(19) United States
(12) Patent Application Publication
(10) Pub. No.: US 2020/0352194 A1
(43) Pub. Date: Nov. 12, 2020

(54) DEVICE FOR SIMULTANEOUS CONSUMPTION OF A FLUID AND A FROZEN SUBSTANCE

(71) Applicant: LIQR POP, LLC, Henderson, NV (US)

(72) Inventors: Tracy Reinhardt, Henderson, NV (US); William Robert Reinhardt, Jr., Henderson, NV (US)

(21) Appl. No.: 16/770,315

(22) PCT Filed: Dec. 7, 2018
(86) PCT No.: PCT/US2018/064613

§ 371 Date: Jun. 5, 2020

Related U.S. Application Data
(60) Provisional application No. 62/596,693, filed on Dec. 8, 2017.
(60) Provisional application No. 62/596,706, filed on Dec. 8, 2017.
(60) Provisional application No. 62/671,387, filed on May 14, 2018.

(51) Int. Cl. A23G 9/28; A23G 9/08; A23G 9/22; F21S 9/02; H05B 47/19; H05B 45/20

(52) U.S. Cl. CPC A23G 9/28; A23G 9/083; H05B 45/20; F21S 9/02; H05B 47/19; A23G 9/221

(57) ABSTRACT

Various embodiments relate to a device for simultaneous consumption of a fluid and a frozen substance. In some embodiments, the device can include a squeezable chamber configured to store at least a portion of the fluid substance. A flange can be connected at a first end to the squeezable chamber. The flange can define a cavity in fluid communication with an interior of the squeezable chamber such that, when the squeezable chamber is squeezed by a user, the fluid substance is driven from the squeezable chamber and through at least a portion of the cavity defined by the flange. In some embodiments, one or more optical emitters can be coupled with the device.

### CROSS-REFERENCE TO RELATED APPLICATIONS

This application claims priority to U.S. Provisional Patent Application No. 62/596,693, filed Dec. 8, 2017; to U.S. Provisional Patent Application No. 62/596,706, filed Dec. 8, 2017; and to U.S. Provisional Patent Application No. 62/671,387, filed May 14, 2018, the entire contents of each of which are hereby incorporated by reference herein in their entirety and for all purposes. This application claims priority to U.S. patent application Ser. No. 14/978,654, filed Dec. 22, 2015, which is a continuation of U.S. patent application Ser. No. 14/328,547, filed Jul. 10, 2014, which claims priority to U.S. Provisional Application No. 61/844,982 filed on Jul. 11, 2013, and to U.S. Provisional Application No. 61/977,785 filed on Apr. 10, 2014, both of which are hereby incorporated by reference in their entirety.

### BACKGROUND

### Field of the Invention

The present disclosure relates generally to a frozen confection or frozen beverage device. More specifically, the present disclosure relates to a device for forming a frozen confection that allows for simultaneous consumption of the frozen confection and a user-controlled quantity of fluid, such as alcohol.

### Description of Related Art

People desire cool refreshments, especially during the hot summer months. Frozen confections, such as ice pops and Popsicles®, are well-known and popular summertime refreshments for people of all ages. A great variety of frozen confection products, having different colors, flavors, textures, fat content, and caloric content, are widely available. In addition to frozen confections, frozen cocktails are well-known and popular summertime refreshments enjoyed by adults. Frozen cocktails are popular in part because they are cold and also because they are alcoholic.

Freezing alcoholic beverages is problematic due to the low freezing point of ethyl alcohol (the alcohol in alcoholic beverages), which is approximately −173° F. under ambient conditions. The freezing point of alcoholic beverages is between the freezing points of water (32° F.) and alcohol (−173° F.), and depends on the beverage's alcohol content. Therefore, it is difficult to freeze alcoholic beverages and confections having higher alcohol content. As such, completely frozen confections such as ice pops and Popsicles® generally do not contain alcohol.

Because of the low freezing point of alcohol, popular frozen cocktails such as margaritas, piña coladas, and daiquiris are far from completely frozen when served. Instead, “frozen” cocktails are served as a slush with ice crystals suspended in the liquid. If the frozen cocktail is not quickly consumed, the ice crystals melt causing the cocktail to have a less desirable texture and temperature.

In addition to frozen cocktails, it is known to mix alcohol with gelatin to produce food products commonly referred to as Jello® shots and pudding shots. For instance, one type of product mixes vodka, or other alcoholic beverage, with a prepared gelatin before the gelatin solidifies or hardens. The gelatin is then chilled and hardens with the alcoholic beverage contained therein. Although these alcoholic gelatin products provide an alternative to frozen cocktails, they too are not completely frozen and therefore not as refreshing as completely frozen refreshments.

In view of the foregoing, there remains a need in the art for a device that allows for simultaneous consumption of the frozen confection and an alcoholic beverage. The present disclosure addresses this particular need, as discussed in detail below.

### SUMMARY OF THE INVENTION

The present disclosure relates to a device for molding a freezable substance and dispensing a stored fluid. More specifically, the present disclosure relates to a device that, when assembled, creates a Popsicle®-like frozen confection having a container holding an alcoholic liquid. The user employs a plunger to drive the alcoholic liquid (or other consumable fluid or flowable substance that has a lower freezing point than that of the frozen confection) upward through one or more lumens or passageways in the frozen confection. Thus, the device allows for an alcoholic liquid and a frozen substance to be ingested simultaneously while being contained separately within a single vessel. The device further allows the user to control the amount of alcohol ingested, and thus the flavor of the product. Using the plunger, the user may shoot alcohol from the device, drizzle the alcohol over the frozen confection, or refrain from ingesting any alcohol at all.

In one embodiment, the device is a four-piece assembly. The first member is a handle with a plunger disposed at one end of the handle. The second member is a flange and a container extending from the flange and receiving at a first end of the container the plunger, the container defining an inner volume to receive and store a fluid substance (which preferably remains dispensable or flowable at temperatures below the freezing point of water). The end of the container generally opposite the end receiving the plunger has an orifice. The third member interacts with the second member at the flange. Finally, the fourth member interacts with the orifice of the container on one end. The fourth member can also interact with the third member. The second, third, and fourth members define a mold cavity for receiving a freezable substance (e.g., a water-based substance that freezes at or around the freezing point of water).

In another embodiment, the device permits molding a freezable substance so that the frozen substance has one or more lumens or pathways through which a fluid or flowable substance (preferably with a lower freezing point than that of the frozen substance) may pass or reside. This device comprises a hollow tubular or cup-like mold. In a preferred embodiment, the mold has an end open to receive a freezable substance and a closed opposing end. Disposed within the mold are one or more shafts, plugs, projections, or mandrels that extend inward from an inner surface of the mold to define the pathways in the frozen substance—for example, from the closed end of the mold toward the open end of the mold. The mold and the projections in some forms are unitary and in other forms are separable. Additionally, the mold can comprise a unitary body or can be formed of two or more pieces.

The present disclosure also relates to a method of forming a food item having a fluid portion and a molded portion comprised of a frozen substance. The fluid portion has a lower freezing point than that of the frozen substance. The method comprises providing a device having a mold cavity and a container. The mold cavity is filled with a freezable substance and sealed. The container is filled with the fluid portion and sealed. In this method, the mold cavity may have an elongated cylindrical shape. Further, the device may include a plunger that inserts into the container. Further, the container may be concentrically disposed within the mold cavity with the device is fully assembled.

In another embodiment, the device comprises one or more optical emitters and a power source. The optical emitters can be attached to the device and may display an array of colors or lighting sequences. The optical emitters can be connected to a wireless communication chip, allowing the emitters to be in electronic communication with an external system. The external system can send signals to the wireless communication chip, which can allow for the optical emitters to display a color or lightning sequence specified by the external system. The power source can power the optical emitters while the optical emitters are operating.

In another embodiment, the device comprises a chamber, housing, and one or more optical emitters. The chamber can be configured to store a portion of a fluid substance. The housing can be coupled to the chamber. Disposed inside the housing can be one or more optical emitters.

In another embodiment, the device can be a part of a system, with the system comprising a consumable product and an external system. The consumable product can consist of an edible substance, one or more optical emitters, and a communications chip that is electrically connected to the emitters. The external system can be configured to send signals to the communications chip.

In another embodiment, the device comprises a squeezable member. The squeezable member can comprise a squeezable chamber that can store a liquid. The squeezable chamber can be in fluid communication with other aspects of the device that form the lumens or pathways. This fluid communication permits a fluid stored in the squeezable chamber to flow through the lumens or pathways upon a user squeezing the squeezable member.

In another embodiment, the device comprises a squeezable chamber, a flange, and a cover. The squeezable chamber is configured to store a portion of the fluid substance. The flange is connected to the squeezable chamber and defines a cavity or passageway for fluid to flow between the squeezable chamber and flange. The cover is removably connected to the flange, defines a mold cavity for a freezable substance, and has a shaft extending through the cover.

In another embodiment, the device comprises a squeezable chamber, a flange, and a frozen confection. The squeezable chamber is configured to store a portion of the fluid substance. The flange is connected to the squeezable chamber and defines a cavity or passageway for fluid to flow between the squeezable chamber and flange. The frozen is connected to the flange on an opposite side from the squeezable chamber.

The present disclosure also relates to dispensing a stored fluid over a frozen confection. A user can squeeze a handle of a device to direct fluid through a lumen and onto a frozen substance. The handle can partially define a squeezable chamber, with the chamber storing the fluid to be dispensed on the frozen substance.

In one embodiment, a device for molding a freezable substance and dispensing a stored fluid substance is disclosed. The device can include a squeezable chamber configured to store at least a portion of the fluid substance. The device can include a flange connected at a first end portion to the squeezable chamber. The flange can define a passageway in fluid communication with an interior of the squeezable chamber such that, when the squeezable chamber is squeezed by a user, the fluid substance is driven from the squeezable chamber and through at least a portion of the passageway defined by the flange. The device can include a cover removably coupled with a second end portion of the flange, the cover having an open end and a closed end and at least partially defining a mold cavity for molding the freezable substance, the cover having a shaft extending from the closed end. A length of the shaft can be at least half a length of the cover.

In one embodiment, a device for molding a freezable substance and dispensing a stored fluid substance is disclosed. The device can include a squeezable chamber configured to store at least a portion of the fluid substance. The device can include a flange connected at a first end portion to the squeezable chamber. The flange can define a passageway in fluid communication with an interior of the squeezable chamber such that, when the squeezable chamber is squeezed by a user, the fluid substance is driven from the squeezable chamber and through at least a portion of the passageway defined by the flange. The device can include a frozen confection supported by a second end portion of the flange.

In one embodiment, a method for dispensing a stored fluid over a frozen confection is disclosed. The method can include squeezing a handle that at least partially defines a squeezable chamber that stores the fluid from at least one lateral side of the handle. The method can include directing the fluid through a lumen of the frozen confection.

In one embodiment, a device for molding a frozen substance and dispensing a stored fluid is disclosed. The device can include a first member defining at least in part a squeezable variable-volume chamber configured to receive and store a fluid. The device can include a second member including a flange and an orifice permitting fluid flow across the second member. The squeezable variable-volume chamber can be in communication with the orifice and is disposed on a side of the second member. The device can include a third member including a mold having an open first end that interacts with the second member and a closed second end on an opposite side of the mold from the first end, a first length of the mold being defined between the open first end and the closed second end. The third member can include a shaft extending from the second end of the mold toward the first end of the mold, the shaft interacting with the orifice of the second member, the shaft having a second length that is at least half the first length. The first end of the third member can interact with the flange of the second member to collectively define a mold cavity for holding the frozen substance with the shaft extending through the mold cavity to the orifice, wherein when the third member is removed from the second member, a lumen is formed from the orifice to an exterior of the frozen substance to permit passage of the fluid within the squeezable variable-volume chamber through the orifice, through the lumen, and to an exterior of the frozen substance. When the first member is squeezed, the fluid in the squeezable variable-volume chamber can pass through the orifice, through the lumen, and to the exterior of the frozen substance.

In one embodiment, a device is disclosed. The device can include a chamber configured to store at least a portion of a fluid substance. The device can include a housing coupled to the chamber. The device can include one or more optical emitters disposed in the housing.

In some embodiments, a communications chip can be disposed in the housing and can be electrically connected to the one or more optical emitters.

In one embodiment, a system is disclosed. The system can include a consumable product comprising an edible substance, one or more optical emitters, and a communications chip electrically connected to the one or more optical emitters. The system can include an external system, the external system configured to send signals to the communications chip.

### BRIEF DESCRIPTION OF THE DRAWINGS

FIG. 1 depicts a side view of an exemplary device with the third member removed to expose the frozen confection, in accordance with exemplary embodiments of the invention.

FIG. 2 depicts a top perspective side view of an exemplary device fully assembled, in accordance with exemplary embodiments of the invention.

FIG. 3 depicts a top perspective side view of an exemplary first member, in accordance with exemplary embodiments of the invention.

FIG. 4 depicts a side view of another exemplary first member, in accordance with exemplary embodiments of the invention.

FIG. 5 depicts a side view of an exemplary second member, in accordance with exemplary embodiments of the invention.

FIG. 6 depicts a side view of another exemplary second member, in accordance with exemplary embodiments of the invention.

FIG. 7 depicts a side view of an exemplary third member, in accordance with exemplary embodiments of the invention.

FIG. 8 depicts a side view of an exemplary third member and its internal structure, in accordance with exemplary embodiments of the invention.

FIG. 9 depicts a side view of another exemplary second member with rings to prevent the frozen confection from slipping, in accordance with exemplary embodiments of the invention.

FIG. 10 depicts a side view of an exemplary device fully assembled, in accordance with exemplary embodiments of the invention.

FIG. 11 is a schematic view of a consumable product having a handle comprising one or more optical emitters.

FIG. 11A is a schematic enlarged sectional view of a portion of the consumable produce of FIG. 11.

FIG. 12 illustrates another embodiment of an apparatus for consuming a freezable confection that includes one or more optical emitters.

FIG. 12A is a schematic enlarged sectional view of a portion of the consumable produce of FIG. 12.

FIG. 13 is a schematic side view of a consumable product with a squeezable handle configured to drive a stored fluid substance over a freezable confection, according to various embodiments.

### DETAILED DESCRIPTION OF THE INVENTION

The present disclosure relates to a device for molding a freezable substance and dispensing a stored fluid substance. More specifically, the present disclosure relates to a device that, when assembled, creates a Popsicle®-like frozen confection having a container holding an alcoholic liquid. The user employs a plunger to drive the alcoholic liquid upward through a lumen in the frozen confection so that the user may simultaneously consume the frozen confection and ingest the alcoholic beverage. Thus, the device allows for an alcoholic liquid and a frozen substance to be ingested simultaneously while being contained separately within a single vessel. The device further allows the user to control the amount of alcohol ingested, and thus the flavor of the product. Using the plunger, the user may shoot alcohol from the device, drizzle the alcohol over the frozen confection, or refrain from ingesting any alcohol at all.

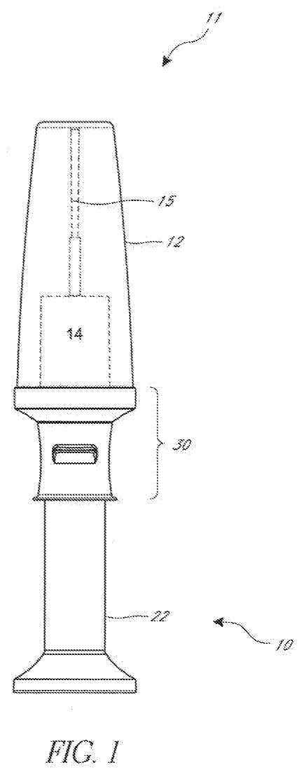

The drawings are for purposes of illustrating a preferred embodiment of the present disclosure, and not for purposes of limiting the same. Turning now to the drawings, as shown in FIGS. 1-10, there is provided a device 10 for preparing, storing, and serving a chilled item having an outer portion comprised of a freezable confection 12 and an inner portion comprised of a fluid 14, preferably an alcoholic beverage. In this regard, the device 10 is configured to allow a person to simultaneously consume a frozen confection 12 and a fluid 14.

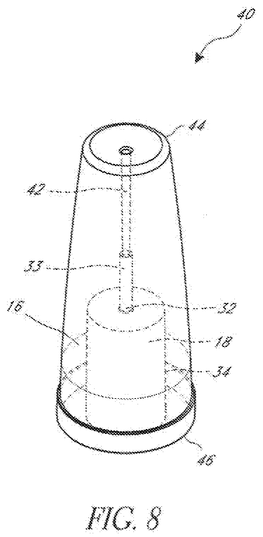

More specifically, as shown in FIGS. 1 and 8, the device 10 includes a mold cavity 16 for receiving and storing the freezable confection 12, and an internal cavity 18 for receiving and storing the fluid 14. The device 10 allows the user to push upward on a handle 22 to displace the fluid 14 from an orifice 32 in the top of a container 34 and through a lumen 15 in the frozen confection 12 and out the top of the frozen confection 12. Thus, the mold cavity 16 and the internal cavity 18 are configured to allow a person to consume simultaneously the frozen confection 12 and the fluid 14. The design and operation of the device 10 is similar to the design and operation of a syringe.

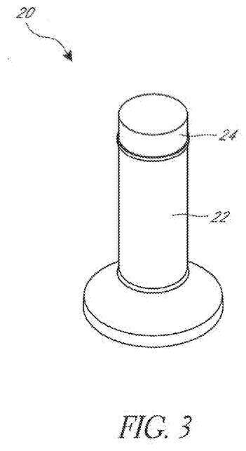

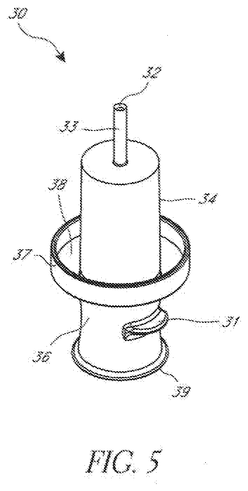

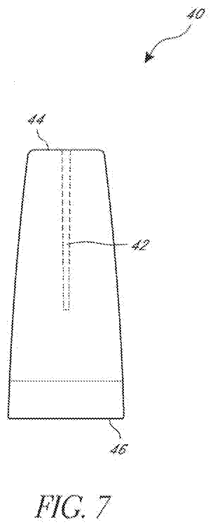

In some embodiments, the device 10 may be comprised of four members. As shown in FIG. 3, a first member 20 is akin to the plunger of a syringe. The first member 20 is comprised of a handle 22 and a plunger 24 that is disposed at the end of the handle 22. As shown in FIGS. 3 and 5, a second member 30 (akin to the barrel of a syringe) includes a flange 36 and a container 34 extending from the flange sized to receive the plunger 24 of the first member 20. The top of the container 34 has an orifice 32 and plug receiver 33 through which the fluid may pass. As shown in FIGS. 5 and 7, a third member 40 interacts with the second member 30 at the flange 36 and the plug receiver 33 at the top of the container 34 to collectively define a mold cavity 16 for molding a freezable substance. The third member 40 may be comprised of two separate members—a member that interacts with the second member 30 at the flange 36, and a fourth member that interacts with the plug receiver 33, or these third and fourth members may be integrally formed.

As described in detail below, the second and third members 30,40 are disposed in the assembled configuration to collectively form the mold cavity 16 within which the freezable confection 12 may be poured, stored, and frozen. Further, the first, second, and third members 20, 30,40 are disposed in the assembled configuration to collectively form the internal cavity 18 within which the fluid 14 may be poured, stored, and chilled. When the user desires to consume the frozen confection 12 and the fluid 14, the third member 40 is twisted and removed from the second member 30 to expose the frozen confection 12 and to access to the fluid 14, yielding the consumable product 11 shown in FIG. 1.

With reference now to FIGS. 1 and 8, it is contemplated that the internal cavity 18 may be pre-filled with a fluid 14 and the mold cavity 16 may be pre-filled with a freezable confection 12 at a manufacturing facility. The device 10 may be transported and stocked at room temperature for an extended shelf life. After the device 10 is purchased by the vendor or consumer, the device 10 may be chilled prior to consumption to freeze the confection 12 and to chill the fluid 14.

As shown in FIG. 3, the first member 20 includes a handle 22 with a plunger 24 disposed at one end. The first member 20 functions like the plunger of a syringe. The plunger 24 defines a cylindrical shape. In preferred embodiments, the handle 22 also defines a cylindrical shape, wherein the circumference of the handle 22 is approximately equivalent to the circumference of the plunger, as depicted in FIG. 3. Such a design is advantageous because it prevents the first member 20 from slipping when inserted into the second member 30, thereby preventing the plunger 24 from becoming disengaged from the inner wall of the container 34, which would result in fluid 14 leaking out of the container 34.

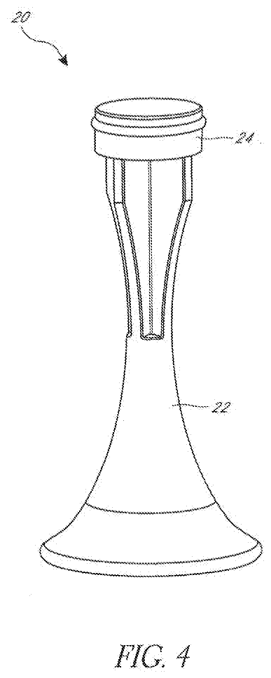

In an alternative embodiment, as depicted in FIG. 4, the handle 22 defines a generally cylindrical shape where the circumference of the cylinder is smaller in the center of the handle 22 and gradually increases toward both ends of the handle. Furthermore, the handle 22 defines an ergonomic configuration with indents which are complimentary to a user's hand. The handle 22 is configured to facilitate clutching or gripping of the device by the user. As such, the handle 22 extends downward from the second member 30 shown in FIG. 5 to define a length that is suitable to enable a user to grip or clutch the device via the handle 22. The shape of the handle 22 is exemplary in nature only, and those skilled in the art will appreciate that other configurations may be used without departing from the spirit and scope of the present invention.

The plunger member 24 is configured to be removably inserted within the container 34 of the second member 30, as shown in FIG. 5. The second member 30 functions like the barrel of a syringe. In this regard, the container 34 includes an inner wall sized to receive the plunger 24 and handle 22. Furthermore, the plunger 24 and handle 22 may define an outer wall that is complimentary in size and shape to the inner wall of the container 34 to enable insertion of the plunger 24 and handle 22 through the container 34.

The plunger cap 24 may be formed of any material commonly used in syringes (i.e., rubber). The plunger material must have properties that allow the plunger to slide easily along the inner wall of the container 34, and that provide a sufficiently secure engagement so as to contain the fluid within the container 34.

A hollowed-out portion of the inner wall of the container 34, sized to receive and capture the plunger 24, forms a ring extending radially outward from the inner wall of the container. If the user attempts to pull the first member 20 out of the second member 30 when the device 10 is fully assembled, the hollowed-out portion captures the plunger 24 because the plunger expands upon entering the hollowed-out portion. Thus, the hollowed-out portion prevents the plunger 24 from being easily or inadvertently removed from the container 34, thereby resulting in fewer spillages of the fluid 14. In alternative embodiments, a ring extends radially inward from the inner wall of the container, also preventing the plunger 24 from being easily or inadvertently removed from the container 34.

As shown in FIG. 5, the container 34 receives the plunger 24 at one end thereof and has an orifice 32 at the generally opposite end thereof, the orifice 32 having a circumference smaller than that of the container 34. The orifice 32 may be directly opposite the side of the container receiving the plunger, or it may be located toward the end of the container not receiving the plunger. The orifice should be positioned such that at least half of the volume of the container is displaced before the plunger is adjacent to the orifice. Alternatively, the orifice should be positioned such that at least 75% of the volume of the container is displaced before the plunger is adjacent to the orifice. Alternatively, the orifice should be positioned such that at least 90% of the volume of the container is displaced before the plunger is adjacent to the orifice. Preferably, the orifice should be positioned such that all of the volume of the container is displaced before the plunger is adjacent to the orifice. The container 34 extends from the orifice 32 in a first direction and a plug receiver 33 extends from the orifice 32 in an opposing second direction. The internal cavity 18 depicted in FIG. 8 is collectively defined by the container 34, the plunger 24, and a solid cylindrical shaft 42 that plugs into the orifice 32 of the container 34 through the plug receiver 33. A plug receiver is advantageous because it provides a better seal between the second and third members, because it allows for easier assembly, and because it prevents pooling of the fluid 14 on top of the container when the device is used and thereby prevents unwanted melting of the frozen substance.

As shown in FIG. 8, the volume of the internal cavity 18 correlates to the amount of fluid capable of being dispensed by the device. In preferred embodiments, the internal cavity 18 defines a volume of 25 ml. In other embodiments, the internal cavity 18 defines a volume of at least 100 ml. In others embodiments, the internal cavity 18 may define a volume ranging from 1 ml to 25 ml. In others embodiments, the internal cavity 18 may define a volume ranging from 25 ml to 50 ml. In others embodiments, the internal cavity 18 may define a volume ranging from 50 ml to 75 ml. In others embodiments, the internal cavity 18 may define a volume ranging from 75 ml to 100 ml.

In preferred embodiments, the mold cavity 16 defines a volume of 75 ml. In other embodiments, the mold cavity 16 defines a volume of at least 300 ml. In other embodiments, the mold cavity 16 may define a volume ranging from 25 ml to 75 ml. In other embodiments, the mold cavity 16 may define a volume ranging from 75 ml to 125 ml. In other embodiments, the mold cavity 16 may define a volume ranging from 125 ml to 175 ml. In other embodiments, the mold cavity 16 may define a volume ranging from 175 ml to 300 ml.

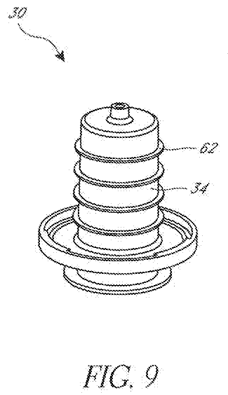

In preferred embodiments, the outer surface of the container 34 may define an irregular, or roughened surface for mitigating inadvertent sliding of the confection 12 along the container 34. Alternatively, as shown in FIG. 5, the outer surface of the container 34 is smooth. A smooth outer surface can be advantageous because it enables the container to be easily removed from a mold during the manufacturing process. FIG. 9 shows a container 34 having series of rings 62 disposed in spaced relation to each other along the length of the container 34. The rings 62 extend radially outward into the frozen confection to mitigate inadvertent sliding of the confection along the container 34. Although rings 62 are shown in FIG. 9, it is contemplated that the outer surface of the container 34 may be roughened to mitigate sliding of the confection along the container 34. Another embodiment of the container 34 may have a plurality of nodules disposed on the outer surface of the container 34 to mitigate inadvertent sliding of the confection 12 along the container 34. The nodules may be semi-spherical and may be evenly spaced along the container 34. Those skilled in the art will appreciate that the nodules may define other shapes, and may be irregularly spaced along the container 34.

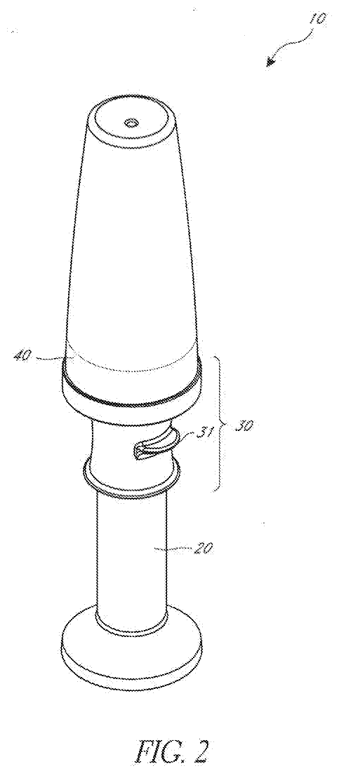

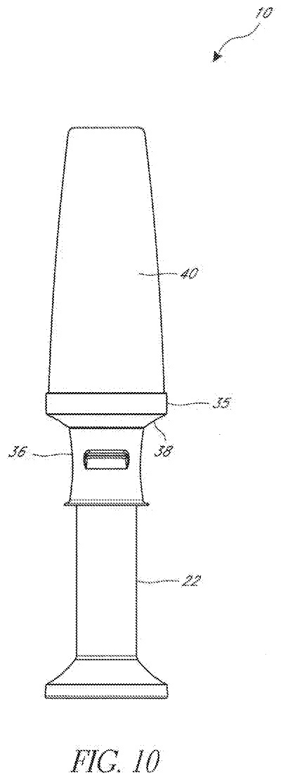

The second member 30, as shown in FIG. 5, includes a flange 36 integrally formed to a container. Referring now to FIGS. 2 and 10, when the first member 20 is inserted into the second member 30 in the assembled configuration, the container 34 extends from the flange 36 in a first direction and the first member 20 extends from the flange 36 in an opposing second direction. The flange 36 defines a circular disc shape having an outer diameter that is larger than that of the handle 22 and the container 34.

In some embodiments, a cylindrical ring 38 extends radially outward from the flange 36 to define a radial edge. The cylindrical ring 38 circumnavigates the container 34. The cylindrical ring 38 is configured to engage with the third member 40, as described in detail below. The container is concentrically disposed relative to the third member when the third member is connected to the second member.

The flange 36 may include an outer edge 37 circumnavigating the cylindrical ring 38 and extending from the cylindrical ring adjacent the radial edge. The outer edge 37 and the cylinder ring 38 collectively define a drip guard useful for catching the frozen confection 12 as it melts. Alternatively, the flange 36 may include an outer edge 35 circumnavigating the cylindrical ring 38 that flares radially outward. This embodiment is advantageous if the user desires to drink the melted remains of the frozen confection 12 from the drip guard.

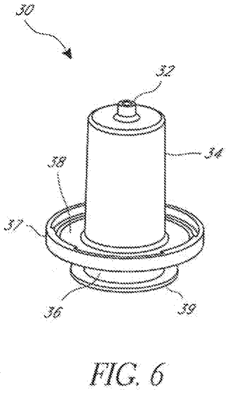

Some embodiments of the flange 36 may be configured to allow a user to easily and securely hold the second member 30 stationary while driving the first member upward through the container 34 so as to displace the fluid from the container through the lumen and into a person's mouth. In preferred embodiments, as shown in FIG. 2, a tab extends radially outward from the outer wall of the flange, sized such that a user can place a finger on the tab to prevent the second member 20 from moving while the user presses the first member 20 upward. In other embodiments, such as that depicted in FIG. 6, the flange 36 may include a grip ring 39 circumnavigating the flange and extending radially outward from the flange to define a second radial edge. The user may then hold the flange 36 in the indented portion between the grip ring 39 and the cylindrical ring 38.

As shown in FIG. 5, the flange 36 defines a flange length between the two ends of the flange's shaft. In some embodiments, the flange length measures between % inch and % inch. In other embodiments, the flange length measures between % inch and 1% inches. In other embodiments, the flange length measures between 1% inches and 2 inches.

As shown in FIG. 7, the third member 40 has an enclosed end 44 and an opposing open end 46. The third member 40 is hollow to define an opening extending axially from the open end 46 to the closed end 44. In the embodiment depicted in FIG. 7, the third member 40 defines a tubular cross-section in a direction perpendicular to its longitudinal axis, wherein the third member 40 is tapered such that the diameter adjacent the enclosed end 44 is smaller than the diameter adjacent the opposing open end 46. Those skilled in the art will appreciate that the third member 40 may define a cross-section that is uniform along its length (i.e., not tapered), or other shapes (i.e., quadrangular, triangular, etc.) without departing from the spirit and scope of the present invention. As one example, the third member 40 may be a flared cylinder wherein the closed end diameter is 65% to 95% of the open end diameter.

The third member 40 defines a third member length from the open end 46 to the opposing enclosed end 44. The container 34 defines a container length from its end receiving the plug to the orifice 32, wherein the container length is less than the third member length. The container 34 may extend to various lengths. For example, the container length may extend between 10% and 25% of the third member length. Alternatively, the container length may extend between 25% and 50% of the third member length.

As shown in FIG. 8, disposed within the mold cavity 16 of the third member 40 is a shaft 42 extending from the center of the closed end 44 of the third member 40 toward the open end 46 of the third member. The shaft interacts with the second member. The shaft 42 is configured to be removably inserted through the plug receiver 33 and the orifice 32, such that the shaft extends partially into the container 34. In this regard, the orifice 32 and the plug receiver 33 have inner walls sized to receive the shaft 42. Furthermore, the shaft 42 may define an outer wall that is complimentary in size and shape to the inner walls of the orifice 32 and the plug receiver 33 to enable insertion of the shaft 42 through the orifice 32. In preferred embodiments, the shaft 42 is solid and has a generally cylindrical shape, with a circumference that decreases gradually towards the open end of the third member 30, such that the solid shaft 42 snuggly fits into the plug receiver 33 and forms a barrier between the fluid and the frozen substance.

In preferred embodiments, the solid shaft 42 extends partially into the internal cavity 18. Such an embodiment is advantageous in the event that the frozen substance inadvertently enters the plug receiver 33 or the internal cavity 18, where the extension of the solid shaft 42 into the internal cavity 18 prevents a blockage of the lumen 15 when the device 10 is frozen.

In alternative embodiments as depicted by FIG. 6, there may be no plug receiver. Also, the solid shaft 42 may be cylindrical. Along these lines, the solid shaft 42 of the third member 40 and the orifice 34 of the second member 30 may be configured to cooperatively engage via press-fit/frictional engagement to secure the solid cylindrical shaft 42 to the second member 30. The engagement is secure enough to contain the fluid within the container 34.

With reference to FIGS. 2 and 8, the third member 40 interacts with the second member 30 to collectively define the mold cavity 16. More specifically, the mold cavity 16 is defined by the inner wall of the third member 40, the outer wall of the container 34, the cylindrical ring 38 (shown in FIG. 5), and the solid shaft 42. Before the device 10 is assembled, a first substance, such as a freezable confection, is poured or otherwise disposed within the mold cavity 16 to mold the first substance therein. Referring now to FIG. 1, after the device 10 is assembled and frozen, the third member 40 is removed from the second member 30, and a lumen 15 remains where the solid shaft 42 existed. It is contemplated that the third member 40 may have more than one shaft extending from its closed end to plug more than one orifice 32, such that when the user removes the third member 40, multiple lumens remain. The solid shaft 42 of the third member bears an advantage over prior art including a straw-like structure extending from a reservoir upward through a frozen substance-here, a lumen 15 replaces the straw-like structure, and the user is able to consume the frozen substance without having the straw-like structure inhibit the licking or sucking of the frozen substance as the frozen substance dissipates.

The second and third members 30, 40 interact with each other when the device is assembled. The second and third members 30, 40 may include structural features to facilitate engagement between the second member 30 and the third member 40. In the embodiment depicted in FIGS. 2 and 5, the third member 40 engages with the cylindrical ring 38 and the outer edge 37 when the third member 40 is coupled to the second member 30. Along these lines, the open end 46 of the third member 40 and the outer edge 37 of the second member 30 may be configured to cooperatively engage via a screw cap engagement to secure the third member 40 to the second member 30. Alternatively, the open end 46 of the third member 40 and the cylindrical ring 38 of the second member 30 may be configured to cooperatively engage via press-fit/frictional engagement to secure the third member 40 to the second member 30. An o-ring formed of a soft plastic may be disposed on the upward-facing side of the cylindrical ring 38, allowing for a more secure engagement between the second member 30 and the third member 40. The engagement is secure enough to contain the freezable confection within the mold cavity 16 when the confection is in liquid form.

Although the foregoing describes a cylindrical ring 38 to facilitate engagement between the second and third members 30, 40, it is contemplated that other engagement techniques may also be employed. For instance, the flange 36 may define a groove into which the open end 46 of the third member 40 may be inserted to engage the second member 30 to the third member 40.

In some embodiments, the second member 30 is formed from a unitary body, as shown in FIG. 5. In other words, the flange 36 and container 34 comprise a single unit. Other embodiments may include a second member 30 formed from a plurality of elements. More specifically, the second member 30 may include a container 34 that is configured to be removably inserted within the flange 36 to define a nested configuration. In this regard, the flange 36 includes an inner wall sized to receive the container 34. Furthermore, the container 34 may define an outer wall that is complimentary in shape and size to the inner wall of the flange 36 to enable insertion and nesting of the container 34 within the flange 36. The detachable configuration of the container 34 and flange 36 may advantageously allow for refilling of the container 34 with the fluid during use of the device 10. In other words, the container 34 and first member 20 may be removed from the flange 36 to refill the internal cavity 18 through the orifice 32 at a location spaced from the flange 36 to mitigate inadvertent spilling of the fluid 14 onto the confection 12 during the refilling process.

The first, second, and third members 20, 30, 40, are preferably formed of a material that can withstand the freezing temperatures that are necessary to freeze the freezable confection. Furthermore, the first, second, and third members are preferably formed of a material that can withstand any expansion or contraction of the confection as it is frozen or heated. Along these lines, it may be preferable to not completely fill the mold cavity 16 with the freezable confection to allow for expansion of the confection during the freezing process.

In some embodiments, LED lights may be incorporated into either the first member 20 or the second member 30. LED lights are advantageous because they allow the user to light up the device 10 when using the device in a dark setting, such as the outdoors at night or indoors in a dimly lit nightclub or restaurant.

Assembly of the device 10 entails the following steps. First, the freezable confection 12 is disposed within the mold cavity 16 through the open end 46 of the third member 40. It is contemplated that the freezable confection 12 may include fruit juices, alcoholic mixers, flavored water, or other freezable confections known in the art. Furthermore, although the majority of the alcoholic beverage is disposed within the container 34, a small amount of the alcoholic beverage may also be mixed with the freezable confection 12, so long as the alcohol does not prevent the confection 12 from freezing (i.e., a small amount of an alcoholic beverage may not prevent the confection 12 from freezing).

Second, the second member 30 is secured to the third member 40, such that the freezable liquid is contained in the mold cavity 16 in a spill-proof manner. Third, the fluid 14 is disposed within the container 34. The fluid 14 may be vodka, rum, tequila, or other alcoholic beverages, as well as non-alcoholic beverages. The fluid 14 also may be any fluid edible product that is not a beverage, such as syrup, sauce, spherical sugar candies, and the like. Fourth, the plunger 24 of the first member 20 is inserted into the container 34, such that the fluid 14 is contained in the internal cavity 18 in a spill-proof manner. The device 10 is then placed within a freezer to freeze the confection 12 and chill the fluid 14.

To consume the confection 12 and the fluid 14, the device 10 is removed from the freezer and the third member 40 is twisted and removed from engagement with the second member 30 to expose the frozen confection 12, as shown in FIG. 1. To consume the frozen confection 12, the user may lick on the frozen confection as he would lick a Popsicle®. To consume the fluid 14, the user may push the first member 20 upward while holding the second member 30 stationary, displacing the fluid 14 from the internal cavity 18 into the lumen 15 within the frozen confection 12 and then into the user's mouth while the user simultaneously sucks on the frozen confection 12. Alternatively, the user may ingest the fluid 14 without pushing upward on the first member 20 by sucking on the frozen confection 12, thereby creating a pressure drop that forces the fluid 14 through the lumen 15 and into a user's mouth. If the user wishes to refrain from ingesting any fluid 14 at all, the user may not push the first member 20 upward. If the user wishes to ingest the fluid 14, the user may push the first member 20 upward quickly, thereby shooting the fluid from the device. Alternatively, the user may push the first member 20 upward slowly, thereby drizzling the fluid over the frozen confection. As such, the device 10 allows the user to simultaneously enjoy the frozen confection 12 and the fluid 14.

The first, second, and third members 20, 30, 40, are preferably formed of a material that is sufficiently durable to allow for washing and reuse (e.g. food-grade polypropylene or other suitable food-grade plastic). Thus, the device 10 may be sold for single use or for multiple uses.

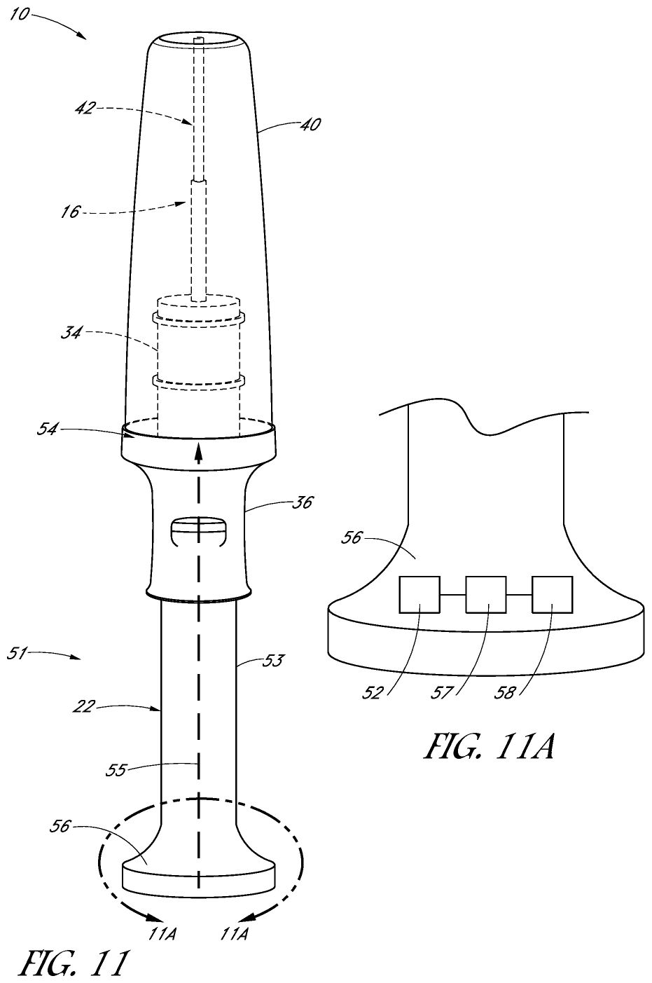

FIG. 11 is a schematic view of a consumable product or device 10 having a handle 22 comprising one or more optical emitters. Unless otherwise noted, the embodiment shown in FIG. 11 can incorporate any or all of the features described above in connection with FIGS. 1-10. Further, unless otherwise denoted, like reference numerals shown in FIG. 11 can denote components that are the same as or generally similar to like-numbered components of FIGS. 1-10. In the embodiment of FIG. 11, the consumable product or device 10 can comprise a chamber 54 configured to store at least a portion of a fluid substance 14, for example, in a member or container 34 extending from a distal portion of the chamber 54, as explained above. A cover 40 (which can be the same as or generally similar to the third member 40 described above) can define a mold cavity 16 for molding a freezable substance (e.g., ice), as explained herein. A housing or enclosure 51 can be coupled to a proximal portion of the chamber 54, and can serve as the handle 22 which the user can grip to consume the product 10. The cover 40 (e.g., third member) can be removably coupled with a distal portion of the chamber 54 and can be disposed over the container 34. As explained above the shaft 42 can extend from an upper portion of the cover 40 to plug an orifice of a container that stores the liquid. As shown in FIG. 7 above, the shaft 42 can have a length that is at least half (e.g., greater than half) a length of the cover 40 or third member. In some embodiments, the shaft 42 can have a length that is about the same length as the cover 40. Beneficially, providing a shaft having a length that is at least half the length of the cover 40 can serve to plug the orifice in fluid communication with the chamber in which the fluid is stored, while enabling the user to enjoy the confection without eating around a stick or shaft disposed through the frozen confection.

One or more optical emitters 52 can be disposed in a proximal or bottom portion 56 of a housing, such as the enclosure 51. One or more communications chips, such as one or more wireless communications chips 57, can be in electrical communication with the one or more optical emitters 52. The one or more wireless communications chips 57 can comprise circuitry configured to convey wireless signals between the one or more optical emitters 52 and an external system (not pictured). For example, the communications chip 57 can comprise circuitry configured to receive a first electrical signal from the external system and, in response, to send a second electrical signal comprising lighting instructions or signals to the one or more optical emitters 52. Additionally, the communications chip 57 can be configured to transmit a third signal to the external system. The third signal can communicate to the external system a state (such as power level, display state, etc.) or location of the device 10. In some embodiments, the communications chip 57 itself may directly send the second electrical signal to the one or more optical emitters 52. In some embodiments, the communications chip 57 can indirectly send the second electrical signal to the one or more optical emitters 52 by way of additional intervening processing chips or circuitry (whether active or passive). In some embodiments, the wireless communications chips 57 can comprise a Bluetooth chip and/or a WiFi communications chip. In some embodiments, both a Bluetooth chip and a WiFi chip can be provided. Furthermore, a power source, such as a battery 58, can be provided in the enclosure 51. The battery 58 can be configured to provide electrical power to the one or more optical emitters 52 and the one or more wireless communications chips 58. Although one emitter 52 is illustrated in FIG. 11, it should be appreciated that a plurality of emitters may be provided.

In various embodiments, the enclosure 51 can comprise a wall 53 (which can be part of the handle 22 and can be disposed about or coupled with a plunger as described above). In various embodiments, the wall 53 can be opaque to visible light and can be colored in any suitable manner, e.g., red, green, blue, etc. The chamber 54 can comprise a translucent wall coupled to a distal portion of the wall 53. A translucent member, such as the container 34, can be coupled to a distal portion of the chamber 54 and may be configured to store the fluid that is to be driven over the frozen substance.

When the user finishes consuming the consumable product, the remaining portion of the device 10 can comprise the enclosure 51 (e.g., opaque and colored), the translucent chamber 54, and the translucent member or container 34. The user may also retain the cover 40, which may be transparent or translucent as shown in the drawings. After consuming the product (or in some cases while consuming the product, or before consuming the product), the user (or an external user or system) can activate the optical emitter(s) 52 which can comprise light emitting diodes (LEDs) in various embodiments. The emitted light can pass along an optical pathway 55, which may involve passing through the housing or enclosure 51, the translucent chamber 54, and the translucent member or container 34. In various embodiments, for example if the cover 40 is replaced over the enclosure 51 and chamber 54, the optical pathway 55 may further pass through the inside of the cover 40 and to the outside environs. In various embodiments (e.g., using white light LEDs), the light can reflect off the colored walls of the enclosure 51 and can form a colored illumination pattern along the enclosure 51. The colored pattern can pass through the translucent chamber 54 (which may be empty of fluid in some embodiments), and can pass through the translucent member or container 34. The light can emerge from the translucent member 34 in a manner similar to that of a flashlight, e.g., the colored light can be directed in any suitable direction or orientation by the user.

In various embodiments, the external system (such as a mobile device, a central server, or any other suitable computing device) can be configured to send signals indicative of when to activate the one or more optical emitters 52. The transmitted signals can be used to selectively turn on and/or off the optical emitters 52. In various embodiments, the external system can be synced with music, such that some musical notes or instruments (e.g., drums, piano, etc.) trigger the illumination of the optical emitters 52. The timing of the illumination of the optical emitters 52 can match or generally mirror the beat of the music in some arrangements. In still other embodiments, an external system user can selectively activate the optical emitters 52 from a central computing device, and the instructions can be transferred to the optical emitters 52 (by way of the communications chips 57) to selectively turn off and/or on the emitters 52. Still other ways of remotely activating the emitters 52 over a wireless communications network (e.g., a WiFi or Bluetooth network) may be suitable. In various embodiments, additional processing circuitry and/or memory devices may be provided in the consumable product to facilitate the activation and/or deactivation of the optical emitters 52 in real-time, and/or to otherwise control the operation of the emitters 52 and the other components of the device 10.

In some embodiments, the optical emitters 52 (e.g., LEDs) can comprise a plurality of colors. The external system can be configured to activate optical emitters 52 based at least in part on one or more acoustic frequencies of the sound(s) being generated or transmitted by the external system. For example, in some embodiments, the external system can be configured to turn on a first optical emitter 52 (e.g., a red LED) when music having one or more acoustic frequencies in a first range of frequencies (or a particular first target frequency) is generated. Similarly, the external system can be configured to turn on a second optical emitter 52 (e.g., a green LED) when music having one or more acoustic frequencies in a second range of frequencies (or a particular second target frequency) is generated. The external system can be configured to turn on a third optical emitter 52 (e.g., a blue LED) when music having one or more acoustic frequencies in a third range of frequencies (or a particular third target frequency) is generated. The external system can be configured to activate the optical emitter 52 by sending a lighting instruction or signal to the communications chip. Any suitable combination of acoustic frequency(ies) and optical emitter color(s) may be synchronized by the system. Further, any particular optical emitter 52 may be turned on or activated at a plurality of different acoustic frequencies (or ranges of frequencies). In addition, for a particular acoustic frequency (or range of frequencies), a plurality of optical emitters 52 (having different or the same colors) may be activated or turned on. Still, other combinations are possible.

In some embodiments, the external system can be configured to activate optical emitters 52 based on actions that occur at an event. For example, when a team at a sporting event scores (such as, a goal, touchdown, homerun, etc.), the external system can send lighting instructions or signals to the communications chip 57 in response to the action. The external system can send instructions in many types of events other than sporting events, such as concerts. The lighting instructions can be based on many types of actions, (such as scoring, an intermission, start of an event, end of the event, a major occurrence during the event, etc.).

In some embodiments, the apparatus disclosed herein can comprise different color emitter(s) 52 corresponding to a particular type of consumable product. For example, in some embodiments, the apparatus can comprise optical emitter(s) 52 configured to emit different colors for different flavors for a particular product (e.g., different colors for cherry, grape, etc.). In some embodiments, the apparatus can comprise optical emitter(s) 52 configured to emit different colors for different sizes of the consumable product (e.g., different colors for large sizes, small sizes, etc.). The apparatus can employ different colors for various other properties of the consumable product.

In some embodiments, the system can activate and/or deactivate (e.g., turn on and/or off) the optical emitter(s) 52 based at least in part on a determined location of a particular consumable product. For example, in some embodiments, the external system can determine a general location of the consumable product within a particular venue (such as a sports stadium, concert venue, etc.) based at least in part on a location of sale of the product. In other embodiments, the external system can determine the location of the consumable product based on a position sensor or module within the device that provides the real-time location of the consumable product. In various embodiments, the external system can activate and/or deactivate the optical emitter(s) 52 at different times based on a desired location of the consumable products. In various embodiments, the system can activate and/or deactivate the optical emitter(s) 52 based on a decision to illuminate the optical emitter(s) 52 of various consumable products located at one or more desired locations. In some embodiments, the external system can be configured to activate the optical emitters 52 based on a signal received from communications chip 57. For example, the communications chip 57 can send a signal to the external system indicating the position of the device 10. In turn, the external system can send the communications chip 57 location-based lighting instructions for the optical emitters 52. The external system can simultaneously send several communications chips 57 different location-based lighting instructions. Other combinations of location-based optical emitter(s) 52 activation may be suitable.

In the embodiment of FIG. 11, the optical emitters 52 are shown as being disposed in a housing such as the bottom portion 56 of the enclosure 51. In some embodiments, the bottom portion 56 can comprise a puck that can be detachable. The detachable bottom portion 56 can be removed and reattached to the enclosure 51 through various connection mechanisms (such as fasteners, threading the bottom portion onto the enclosure 51, snap fit, etc.). A communications chip 57 and battery 58 can be included along with the optical emitters 52 in the detachable bottom portion. In other embodiments, however, the optical emitter(s) 52 can be provided in other portions of the consumable product, including, e.g., at locations above the portion identified in FIG. 11. For example, in other embodiments, the optical emitter(s) 52 can be provided in a housing such as the translucent chamber 54 and/or the colored enclosure (e.g., flange 36) shown in FIG. 11. For example, the optical emitter(s) 52 can emit light upwardly; downwardly; radially outward; upwardly and radially outward; downwardly and radially outward; upwardly, downwardly, and radially outward; or any other suitable combination of directions. In various embodiments, the optical emitter(s) 52 can emit light in multiple directions, including, e.g., generally omnidirectionally.

The device 10 shown and described in connection with FIG. 11 can use a plunger to drive liquid over the freezable confection, as described in connection with FIGS. 1-20. In still other embodiments, the optical emitter(s) 52 can be integrated into different embodiments of a consumable product. For example, in various embodiments, the optical emitter(s) 52 can be disposed in a device 10 for holding a freezable confection 12, as described herein. In other embodiments, the optical emitter(s) 52 can be integrated into other consumable products or the containers for holding such consumable products. For example, in some embodiments, the optical emitter(s) 52 disclosed herein can be integrated with or coupled to beverage containers (e.g., bottles (such as soda bottles, water bottles, beer bottles, etc.), cans, cups, etc.), and/or any suitable lids or covers for beverage containers (e.g., a lid for a cup or a bottle, etc.). In other embodiments, the optical emitter(s) 52 can be integrated with or coupled to food containers or platforms, such as plates, sticks (such as for corn dogs, popsickles, etc.) and/or other types of food packaging apparatus (e.g., cotton candy containers, ice cream containers, etc.).

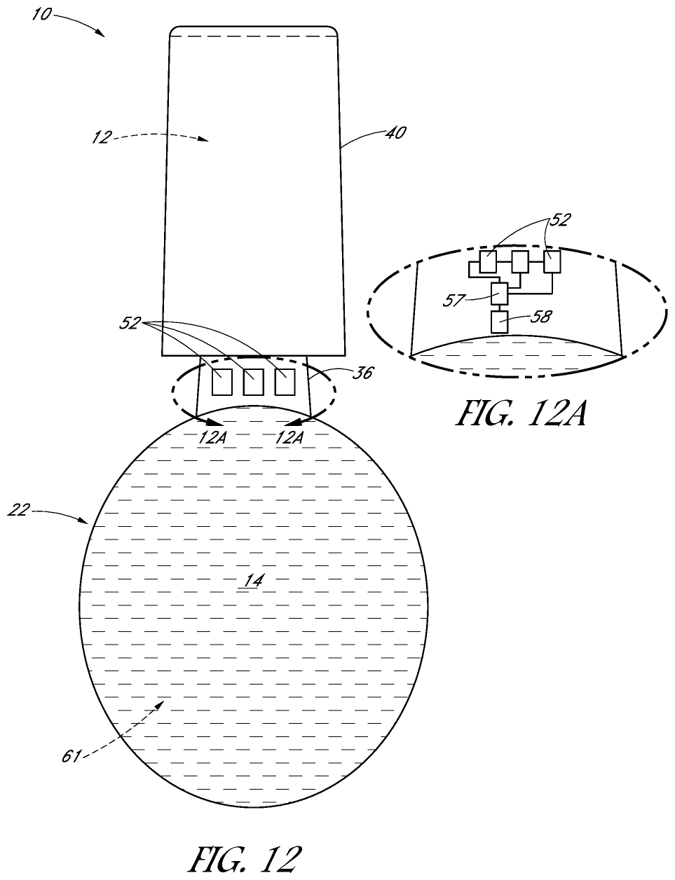

In addition, the optical emitter(s) 52 disclosed herein can be utilized in conjunction with other types of consumable products that comprise a device for holding a freezable confection 12. For example, FIG. 12 illustrates another embodiment of an apparatus or device 10 for consuming a freezable confection 12. In FIG. 12, a cap or cover 40 (which may be similar to the third member described above in some embodiments) can be mechanically coupled to a flange 36 that is in fluid communication with a squeezable or variable volume chamber 61 that is configured to contain a liquid 14, including any of the liquids disclosed herein. The freezable substance 12 can be provided or molded within the cap 40. The user can squeeze the squeezable chamber 61 by squeezing the handle 22 (which can define an outer wall of the variable volume chamber 61) to urge the liquid 14 through the flange 36 and into (or over) the freezable substance 12 once the cap 40 is removed to expose the freezable substance 12. The optical emitter(s) 52 disclosed herein can be provided at any suitable portion of the apparatus disclosed in FIG. 12. For example, in various embodiments, the optical emitter(s) 52 can be provided in a housing that includes the flange 36 shown in FIG. 12 between the squeezable chamber 61 and the cap or cover 40. In various embodiments, as explained above, the optical emitter(s) 52 (e.g., LED(s)) can be configured to emit light in any suitable direction or combination of directions. For example, the optical emitter(s) can emit light upwardly; downwardly; radially outward; upwardly and radially outward; downwardly and radially outward; upwardly, downwardly, and radially outward; or any other suitable combination of directions. In various embodiments, the optical emitter(s) 52 can emit light in multiple directions, including, e.g., generally omnidirectionally.

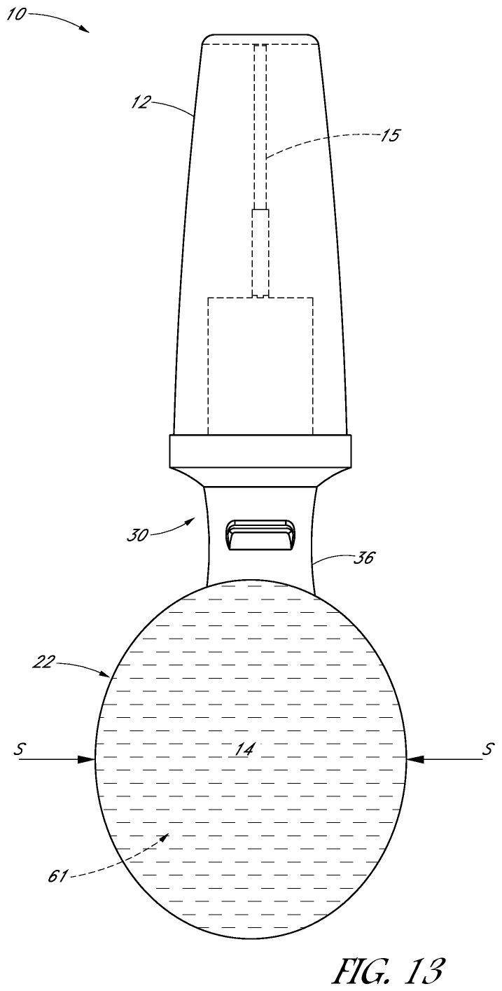

FIG. 13 is a schematic side view of a consumable product or device 10 with a squeezable handle 22 defining a variable volume or squeezable chamber 61 (which may be part of a first member) configured to drive a stored fluid substance 14 over a freezable confection 12, according to various embodiments. Unless otherwise noted, the embodiment of FIG. 13 is generally similar to the embodiments of FIGS. 1-12. Like reference numerals can refer to the same or substantially similar components as those shown in FIGS. 1-12 and can be used in combination with any of the components shown herein with respect to FIGS. 1-12. For example, as with the embodiment of FIG. 8, a third member or cover 40 removably couple to the flange 36 and can define a mold cavity 16 (not shown in FIG. 13) for receiving and storing the freezable confection 12, and an internal cavity 18 can be provided for receiving and storing the fluid 14 in some embodiments. As explained above a shaft 42 can extend from an upper portion of the cover 40 to plug an orifice of a container or reservoir that stores the liquid. As shown in FIG. 7 above, the shaft 42 can have a length that is at least half (e.g., greater than half) a length of the cover 40 or third member (with the length of the cover defined between the open end and the closed end from which the shaft 42 depends). In some embodiments, the shaft 42 can have a length that is about the same length as the cover 40. Beneficially, providing a shaft having a length that is at least half the length of the cover 40 can serve to plug the orifice in fluid communication with the chamber in which the fluid is stored, while enabling the user to enjoy the confection without eating around a stick or shaft disposed through the frozen confection.

Further, as with FIG. 1, the freezable confection 12 can be received within a portion of the second member 30, and the lumen 15 through the freezable confection 12 can be in fluid communication with the stored fluid 14 (which may comprise alcohol). In the illustrated embodiment, at least a portion of the stored fluid 14 may be stored in the internal cavity 18 (e.g., in the container 34). In other embodiments, at least a portion of the stored fluid 14 may be stored in the squeezable chamber or reservoir 61 in the handle 22. In some embodiments, fluid 14 can be stored in both the squeezable chamber 61 in the handle 22 and the internal cavity 18 (e.g., in the container 34). In some embodiments, all the fluid 14 is stored in the squeezable chamber or reservoir 61. As shown in FIG. 13, the second member 30 (which may include the flange 36) can connect to the squeezable handle 22 in any suitable way. Further, the flange 36 can define a cavity or passageway in fluid communication with an interior of the squeezable chamber 61 such that, when the squeezable chamber 61 is squeezed by a user, the lateral walls of the squeezable chamber 61 (at least partially) collapse and the fluid substance 14 is driven from the squeezable chamber 61 and through at least a portion of the cavity or passageway defined by the flange 36.

Thus, to drive the fluid 14 through the lumen 15, the user may squeeze the handle 22 by applying a radially inward force S against the handle 22. In some embodiments, the radially inward force S compresses the handle 22 which in turn reduces the volume of the squeezable chamber 61 to drive the liquid 14 out of the chamber 61. In some embodiments, the handle 22 may comprise a flexible or elastic material that defines the reservoir or chamber 61 for the fluid 14. In some embodiments, the squeezable chamber 61 is defined by one or more lateral wall(s) that collapse when the squeezable chamber 61 is squeezed. The applied force S can drive the fluid out of the handle 22 or squeezable chamber 61 and through the lumen 15, and over the freezable confection 12 as explained above. Beneficially, the embodiment shown in FIG. 13 may provide an improved user experience based on the convenience of applying the squeezing force S. In addition, in some arrangements, the handle 22 of FIG. 13 may avoid other issues, such as situations in which the plunger may decouple or otherwise separate from the remainder of the device.

Throughout all the embodiments disclosed herein, the fluid (e.g., stored fluid 14) can comprise any suitable fluid, e.g., liquid, or a flowable material, e.g., a powder. In various embodiments, the liquid can comprise alcohol, cannabis oil or wax, medicine or therapeutic agents, syrup, or any other suitable liquid bases. In other embodiments, the fluid can comprise cannabis kief. Additionally, in some embodiments, the freezable substance (e.g., freezable confection 12) can be infused with or comprise one or more additives, such as, by way of example only, cannabis crystals, powder, kief, wax, or like forms thereof. For purposes of summarizing the disclosed embodiments and the advantages achieved over the prior art, certain objects and advantages have been described herein. Of course, it is to be understood that not necessarily all such objects or advantages may be achieved in accordance with any particular embodiment. Thus, for example, those skilled in the art will recognize that the disclosed implementations may be embodied or carried out in a manner that achieves or optimizes one advantage or group of advantages as taught or suggested herein without necessarily achieving other objects or advantages as may be taught or suggested herein.

All of these embodiments are intended to be within the scope of this disclosure. These and other embodiments will become readily apparent to those skilled in the art from the following detailed description of the embodiments having reference to the attached figures, the claims not being limited to any particular embodiment(s) disclosed. Although this certain embodiments and examples have been disclosed herein, it will be understood by those skilled in the art that the disclosed implementations extend beyond the specifically disclosed embodiments to other alternative embodiments and/or uses and obvious modifications and equivalents thereof. In addition, while several variations have been shown and described in detail, other modifications will be readily apparent to those of skill in the art based upon this disclosure. It is also contemplated that various combinations or sub-combinations of the specific features and aspects of the embodiments may be made and still fall within the scope. It should be understood that various features and aspects of the disclosed embodiments can be combined with, or substituted for, one another in order to form varying modes of the disclosed implementations. Thus, it is intended that the scope of the subject matter herein disclosed should not be limited by the particular disclosed embodiments described above, but should be determined only by a fair reading of the claims that follow.

What is claimed is:

1. A device for molding a freezable substance and dispensing a stored fluid substance, the device comprising;
a squeezable chamber configured to store at least a portion of the fluid substance;
a flange connected at a first end portion to the squeezable chamber, the flange defining a passageway in fluid communication with an interior of the squeezable chamber such that, when the squeezable chamber is squeezed by a user, the fluid substance is driven from the squeezable chamber and through at least a portion of the passageway defined by the flange; and
a cover removably coupled with a second end portion of the flange, the cover having an open end and a closed end and at least partially defining a mold cavity for molding the freezable substance, the cover having a shaft extending from the closed end,
wherein a length of the shaft is at least half a length of the cover.

2. The device of claim 1, wherein the length of the shaft is greater than the length of the cover.

3. The device of any one of claims 1 to 2, further comprising an internal cavity disposed above the flange, the internal cavity configured to store at least a portion of the fluid substance.

4. The device of any one of claims 1 to 3, further comprising the fluid substance, at least a portion of the fluid substance disposed in the squeezable chamber.

5. The device of claim 4, wherein the fluid substance comprises alcohol.

6. The device of claim 4, wherein the fluid substance comprises cannabis oil.

7. The device of any one of claims 1 to 6, wherein the squeezable chamber is defined at least in part by a handle, the handle comprising a flexible or elastic material.

8. The device of any one of claims 1 to 7, further comprising a frozen confection supported by the flange and disposed within the mold cavity of the cover.

9. The device of claim 8, wherein the frozen confection is molded around the shaft such that, when the cover is removed from the flange, a lumen extends through the frozen confection and is in fluid communication with the fluid in the squeezable chamber.

10. The device of any one of claims 1 to 9, wherein an end of the shaft plugs an orifice in fluid communication with the squeezable chamber.

11. The device of any one of claims 1 to 10, further comprising one or more optical emitters in or on the device.

12. The device of claim 11, wherein the one or more optical emitters is disposed in the flange.

13. The device of any one of claims 11 to 12, further comprising a communications chip that provides wireless communication between the one or more optical emitters and an external system.

14. The device of claim 13, wherein the communications chip comprises circuitry configured to receive a first electrical signal from an external system and, in response, to send a second electrical signal comprising lighting instructions to the one or more optical emitters.

15. The device of any one of claims 11 to 14, further comprising a battery to provide power to the one or more optical emitters.

16. The device of any one of claims 14 to 15, wherein the communications chip comprises circuitry configured to transmit a third signal to the external system indicative of at least one of a state or a location of the device.

17. The device of claim 16, wherein the third signal is indicative of a location of the device, and wherein the lighting instructions cause the one or more optical emitters to emit light at one or more colors or for one or more durations based at least in part on the location of the device.

18. The device of any one of claims 14 to 17, wherein the first electrical signal is indicative of an acoustic frequency or range of acoustic frequencies associated with sound(s) being generated at a location of the device.

19. The device of claim 18, wherein the lighting instructions cause the one or more optical emitters to emit light at one or more colors based at least in part on the acoustic frequency or range of acoustic frequencies.

20. The device of any one of claims 14 to 19, wherein the first electrical signal is indicative of an action that has occurred at a corresponding event or location, and wherein the lighting instructions cause the one or more optical emitters to emit light at one or more colors or for one or more durations based at least in part on the action.

21. The device of claim 20, wherein the corresponding event is a sporting event.

22. The device of claim 20, wherein the corresponding event is a concert.

23. The device of any one of claims 14 to 22, wherein the first electrical signal is associated with music being played at or near a location of the device, and wherein the lighting instructions cause the one or more optical emitters to emit light at one or more colors or for one or more durations based at least in part on the music being played.

24. The device of claim 23, wherein the lighting instructions cause the one or more optical emitters to emit light that generally matches a beat of the music.

25. The device of any one of claims 11 to 24, further comprising a light pathway along which light emitted from the one or more optical emitters is directed.

26. The device of claim 25, wherein the light pathway is directed generally along a length of the device from the housing towards an end of the device.

27. The device of claim 25, wherein the light pathway comprises a generally omnidirectional pathway.

28. The device of any one of claims 11 to 27, wherein the one or more optical emitters comprises a plurality of optical emitters that emit light at a corresponding plurality of colors.

29. The device of any one of claims 11 to 28, wherein the one or more optical emitters comprises one or more light emitting diodes (LEDs).

30. A device for molding a freezable substance and dispensing a stored fluid substance, the device comprising;
a squeezable chamber configured to store at least a portion of the fluid substance; and
a flange connected at a first end portion to the squeezable chamber, the flange defining a passageway in fluid communication with an interior of the squeezable chamber such that, when the squeezable chamber is squeezed by a user, the fluid substance is driven from the squeezable chamber and through at least a portion of the passageway defined by the flange; and
a frozen confection supported by a second end portion of the flange.

31. The device of claim 30, further comprising a cover removably coupled with the second end portion of the flange, the cover having an open end and a closed end and at least partially defining a mold cavity for molding the freezable substance, the frozen confection supported by the flange and disposed within the mold cavity of the cover.

32. The device of claim 31, further comprising a shaft extending from the closed end.

33. The device of claim 32, wherein the frozen confection is molded around the shaft such that, when the cover is removed from the flange, a lumen extends through the frozen confection and is in fluid communication with the fluid in the squeezable chamber

34. The device of any one of claims 32 to 33, wherein an end of the shaft plugs an orifice in fluid communication with the squeezable chamber.

35. The device of any one of claims 32 to 34, wherein a length of the shaft is at least half a length of the cover.

36. The device of any one of claims 30 to 35, further comprising the fluid substance, at least a portion of the fluid substance disposed in the squeezable chamber.

37. The device of claim 36, wherein the fluid substance comprises alcohol.

38. The device of claim 36, wherein the fluid substance comprises cannabis oil.

39. The device of any one of claims 30 to 38, wherein the squeezable chamber is defined at least in part by a handle, the handle comprising a flexible or elastic material.

40. The device of any one of claims 30 to 39, further comprising one or more optical emitters in or on the device.

41. The device of claim 40, wherein the one or more optical emitters is disposed in the flange.

42. The device of any one of claims 40 to 41, further comprising a communications chip that provides wireless communication between the one or more optical emitters and an external system.

43. The device of claim 42, wherein the communications chip comprises circuitry configured to receive a first electrical signal from an external system and, in response, to send a second electrical signal comprising lighting instructions to the one or more optical emitters.

44. The device of any one of claims 40 to 43, further comprising a battery to provide power to the one or more optical emitters.

45. The device of any one of claims 43 to 44, wherein the communications chip comprises circuitry configured to transmit a third signal to the external system indicative of at least one of a state or a location of the device.

46. The device of claim 45, wherein the third signal is indicative of a location of the device, and wherein the lighting instructions cause the one or more optical emitters to emit light at one or more colors or for one or more durations based at least in part on the location of the device.

47. The device of any one of claims 43 to 46, wherein the first electrical signal is indicative of an acoustic frequency or range of acoustic frequencies associated with sound(s) being generated at a location of the device.

48. The device of claim 47, wherein the lighting instructions cause the one or more optical emitters to emit light at one or more colors based at least in part on the acoustic frequency or range of acoustic frequencies.

49. The device of any one of claims 43 to 48, wherein the first electrical signal is indicative of an action that has occurred at a corresponding event or location, and wherein the lighting instructions cause the one or more optical emitters to emit light at one or more colors or for one or more durations based at least in part on the action.

50. The device of claim 49, wherein the corresponding event is a sporting event.

51. The device of claim 49, wherein the corresponding event is a concert.

52. The device of any one of claims 43 to 51, wherein the first electrical signal is associated with music being played at or near a location of the device, and wherein the lighting instructions cause the one or more optical emitters to emit light at one or more colors or for one or more durations based at least in part on the music being played.

53. The device of claim 52, wherein the lighting instructions cause the one or more optical emitters to emit light that generally matches a beat of the music.

54. The device of any one of claims 40 to 53, further comprising a light pathway along which light emitted from the one or more optical emitters is directed.

55. The device of claim 54, wherein the light pathway is directed generally along a length of the device from the housing towards an end of the device.

56. The device of claim 54, wherein the light pathway comprises a generally omnidirectional pathway.

57. The device of any one of claims 40 to 56, wherein the one or more optical emitters comprises a plurality of optical emitters that emit light at a corresponding plurality of colors.

58. The device of any one of claims 40 to 57, wherein the one or more optical emitters comprises one or more light emitting diodes (LEDs).

59. A method for dispensing a stored fluid over a frozen confection, the method comprising:
squeezing a handle that at least partially defines a squeezable chamber that stores the fluid from at least one lateral side of the handle; and
directing the fluid through a lumen of the frozen confection.

60. The method of claim 59, further comprising flowing the fluid over at least a portion of the frozen confection.

61. The method of any one of claims 59 to 60, wherein directing the fluid comprises directing a fluid comprising alcohol.

62. The method of any one of claims 59 to 60, wherein directing the fluid comprises directing a fluid comprising cannabis oil.

63. The method of any one of claims 59 to 62, further comprising forming the lumen by removing a cover disposed over the frozen confection.

64. The method of claim 63, wherein removing the cover comprises removing a shaft that extends from the cover to define the lumen to expose an orifice in fluid communication with the squeezable chamber.

65. A device for molding a frozen substance and dispensing a stored fluid, the device comprising:
a first member defining at least in part a squeezable variable-volume chamber configured to receive and store a fluid;
a second member including a flange and an orifice permitting fluid flow across the second member;
wherein the squeezable variable-volume chamber is in communication with the orifice and is disposed on a side of the second member; and
a third member including:
a mold having an open first end that interacts with the second member and a closed second end on an opposite side of the mold from the first end, a first length of the mold being defined between the open first end and the closed second end; and
a shaft extending from the second end of the mold toward the first end of the mold, the shaft interacting with the orifice of the second member, the shaft having a second length that is at least half the first length,
wherein the first end of the third member interacts with the flange of the second member to collectively define a mold cavity for holding the frozen substance with the shaft extending through the mold cavity to the orifice, wherein when the third member is removed from the second member, a lumen is formed from the orifice to an exterior of the frozen substance to permit passage of the fluid within the squeezable variable-volume chamber through the orifice, through the lumen, and to an exterior of the frozen substance, and wherein when the first member is squeezed, the fluid in the squeezable variable-volume chamber passes through the orifice, through the lumen, and to the exterior of the frozen substance.

66. The device of claim 65, further comprising the frozen substance, the frozen substance stored inside the mold cavity and interacting with the flange.

67. A device comprising;
a chamber configured to store at least a portion of a fluid substance;
a housing coupled to the chamber; and
one or more optical emitters disposed in the housing.

68. The device of claim 67, further comprising a communications chip disposed in the housing and in electrical communication with the one or more optical emitters.

69. The device of any one of claims 67 to 68, wherein the one or more optical emitters are disposed on a lower portion of the housing.

70. The device of any one of claims 67 to 68, wherein the housing comprises a flange positioned to support a freezable substance on a first side of the flange, the chamber disposed on a second side of the flange.

71. The device of any one of claims 67 to 70, wherein the freezable substance is coupled to the housing.

72. The device of claim 71, wherein the one or more optical emitters are positioned to emit light at least through the housing and the freezable substance.

73. The device of any one of claims 67 to 72 wherein the device comprises a device for molding a freezable substance and dispensing the stored fluid substance.

74. The device of claim 73, wherein the device comprises a flange positioned to support the freezable substance, the device configured to direct the stored fluid substance from the chamber through a lumen of the freezable substance.

75. The device of claim 74, wherein the chamber comprises a variable volume chamber.

76. The device of claim 75, wherein the variable volume chamber comprises a squeezable chamber in which the stored fluid substance is driven through the lumen upon exertion of a squeezing force against the squeezable chamber.

77. The device of claim 75, wherein the variable volume chamber operably engages with a plunger such that translational movement of the plunger drives the stored fluid substance through the lumen, the variable volume chamber at least partially defined by the plunger.

78. The device of any one of claims 68 to 77, wherein the communications chip comprises one or more wireless communications chips in electrical communication with the one or more optical emitters, the one or more wireless communications chips configured to convey wireless signals between the one or more optical emitters and an external system.

79. The device of any one of claims 68 to 78, further comprising a battery in the housing, the battery configured to provide electrical power to the one or more optical emitters and the communications chip.

80. The device of any one of claims 68 to 79, further comprising an external system, the external system configured to send signals indicative of when to activate the one or more optical emitters.

81. The device of any one of claims 67 to 80, wherein the housing comprises an opaque wall.

82. The device of claim 81, wherein the chamber comprises a translucent wall disposed at a distal portion of the opaque wall.

83. The device of claim 81, further comprising a translucent member coupled to a distal portion of the chamber.

84. The device of any one of claims 67 to 83, wherein the device is configured to synchronize the activation of a color of the one or more optical emitters with a corresponding acoustic frequency or range of acoustic frequencies being generated by an external system.

85. The device of any one of claims 68 to 84, wherein the communications chip comprises circuitry configured to receive a first electrical signal from an external system and, in response, to send a second electrical signal comprising lighting instructions to the one or more optical emitters.

86. The device of claim 85, wherein the communications chip comprises circuitry configured to transmit a third signal to the external system indicative of at least one of a state or a location of the device.

87. The device of claim 86, wherein the third signal is indicative of a location of the device, and wherein the lighting instructions cause the one or more optical emitters to emit light at one or more colors or for one or more durations based at least in part on the location of the device.

88. The device of any one of claims 85 to 87, wherein the first electrical signal is indicative of an acoustic frequency or range of acoustic frequencies associated with sound(s) being generated at a location of the device.

89. The device of claim 88, wherein the lighting instructions cause the one or more optical emitters to emit light at one or more colors based at least in part on the acoustic frequency or range of acoustic frequencies.

90. The device of any one of claims 85 to 89, wherein the first electrical signal is indicative of an action that has occurred at a corresponding event or location, and wherein the lighting instructions cause the one or more optical emitters to emit light at one or more colors or for one or more durations based at least in part on the action.

91. The device of claim 90, wherein the corresponding event is a sporting event.

92. The device of claim 90, wherein the corresponding event is a concert.

93. The device of any one of claims 85 to 92, wherein the first electrical signal is associated with music being played at or near a location of the device, and wherein the lighting instructions cause the one or more optical emitters to emit light at one or more colors or for one or more durations based at least in part on the music being played.

94. The device of claim 93, wherein the lighting instructions cause the one or more optical emitters to emit light that generally matches a beat of the music.

95. The device of any one of claims 67 to 94, further comprising a light pathway along which light emitted from the one or more optical emitters is directed.

96. The device of claim 95, wherein the light pathway is directed generally along a length of the device from the housing towards an end of the device.

97. The device of claim 95, wherein the light pathway comprises a generally omnidirectional pathway.

98. The device of any one of claims 67 to 97, wherein the one or more optical emitters comprises a plurality of optical emitters that emit light at a corresponding plurality of colors.

99. The device of any one of claims 67 to 98, wherein the one or more optical emitters comprises one or more light emitting diodes (LEDs).

100. A system comprising;
a consumable product comprising an edible substance, one or more optical emitters, and a communications chip electrically connected to the one or more optical emitters; and
an external system, the external system configured to send signals to the communications chip.

101. The system of claim 100, wherein the communications chip comprises circuitry configured to receive a first electrical signal from the external system and, in response, to send a second electrical signal comprising lighting instructions to the one or more optical emitters.

102. The system of claim 101, wherein the communications chip comprises circuitry configured to transmit a third signal to the external system.

103. The system of claim 102, wherein the third signal is indicative of the location of a device in relation to a corresponding event.

104. The system of any one of claims 102 to 103, wherein the first electrical signal is indicative of an acoustic frequency or range of acoustic frequencies associated with sound(s) being generated at a location of the device.

105. The system of any one of claims 101 to 104, wherein the first electrical signal is indicative of an action that has occurred at a corresponding event.

106. The system of any one of claims 103 or 105, wherein the corresponding event is a sporting event.

107. The system of any one of claims 103 or 105, wherein the corresponding event is a concert.

108. The system of any of the claims 100 to 107, wherein the communications chip comprises one or more wireless communications chips in electrical communication with the one or more optical emitters, the one or more wireless communications chips configured to convey wireless signals between the one or more optical emitters and the external system.

109. The system of any of the claims 100 to 108, further comprising a battery connected to the one or more optical emitters and the communications chip, the battery configured to provide electrical power to the one or more optical emitters and the communications chip.

110. The system of any of the claims 100 to 109, wherein the one or more emitters emit light through the consumable product.

111. The system of any of the claims 100 to 110, wherein the consumable product is a frozen confection.

112. The system of any of the claims 100 to 111, wherein the one or more emitters emit light omnidirectionally.
